(19) United States
(12) Patent Application Publication
(10) Pub. No.: US 2005/0248313 A1
(43) Pub. Date: Nov. 10, 2005

(54) Event-driven battery charging and reconditioning

(76) Inventor: Miles K. Thorland, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 10/838,632

(22) Filed: May 4, 2004

(51) Int. Cl. H02J 7/00

(52) U.S. Cl. 320/130

(57) ABSTRACT

Event-driven battery charging charges or reconditions and charges a rechargeable battery in response to a detected upcoming event. An upcoming event is a member of a list of events stored in computer-readable memory. Each member has respective occurrence information. The upcoming event is detected when a current date or date and time corresponds to the occurrence information for a respective event in the list. A battery charger includes the list of events stored in the memory, a clock, a battery charging subsystem and a controller that controls the battery charging subsystem. A battery-powered device includes the list of events stored in the memory, a clock, a battery charging subsystem, a controller, and a computer program stored in the memory and executed by the controller. The computer program includes instructions that implement detecting an upcoming event and charging the battery in situ when the upcoming event is detected.

### BACKGROUND

1. Technical Field

The invention relates to battery-powered devices. In particular, the invention relates to charging and reconditioning rechargeable batteries used with battery-powered devices.

2. Description of Related Art

Battery-powered devices, such as digital cameras for example, generally depend on a battery-based power supply for their operational power. In particular, a battery-based power supply that employs a rechargeable battery is often used in such portable battery-powered devices. The rechargeable battery of the battery-based power supply provides the device with operational power without requiring a continuous connection to a fixed power source, such as an alternating current (AC) electrical outlet, thus facilitating portable operation of the device. In general, the device may be operated from battery power until the battery becomes depleted. When depleted, the battery is either recharged in situ or is replaced with a fully charged, replacement battery. When not recharged in situ, the rechargeable battery is typically recharged in a recharging unit that is separate from the device.

A battery-powered device is often employed in a fairly sporadic or aperiodic fashion. For example, the battery-powered device may be stored or remain unused for long periods. When the battery-powered device is used, the use may entail relatively high levels of operation intensity. To support such battery-powered device, rechargeable batteries and battery charging or recharging methodologies employed therewith ideally must be able to accommodate such sporadic usage profiles.

Rechargeable batteries used with battery-powered devices are available in a number of different types or chemistries including, but not limited to nickel metal hydride (NiMH), lithium ion (Li), and nickel cadmium (NiCd). Most rechargeable batteries experience a gradual loss of stored energy or stored charge through internal leakage currents during storage periods or other periods of relatively low usage of the battery-powered device. Such gradual loss of stored energy typically necessitates periodic recharging or ‘topping off’ of the battery charge to maintain a peak or maximum energy capacity and maximum usage availability during active periods for the device. In addition, of the various rechargeable battery types, some require periodic reconditioning to achieve or maintain peak battery capacity and performance. For example, without periodic reconditioning during use, NiMH and NiCd batteries tend to develop a reduced battery storage capacity over time. Regular, periodic battery reconditioning of NiMH and NiCd batteries helps to reduce or even reverse the reduction of charge capacity.

Accordingly, it would be advantageous to have a way of maintaining a peak charge or charge capacity of a rechargeable battery used in a battery-powered device that accommodated sporadic use of the battery-powered device. Such a way of maintaining a peak charge and/or charge capacity would address a long-standing need in the area of battery-powered devices that utilize rechargeable batteries.

### BRIEF SUMMARY

In some embodiments of the present invention, a method of event-driven battery charging of a battery is provided. The method comprises charging a rechargeable battery in response to a detected upcoming event. The upcoming event is a member of a list of events stored in computer-readable memory, each member having respective occurrence information in the list indicative of a date or a date and time of occurrence.

In other embodiments of the present invention, a method of event-driven battery reconditioning and charging is provided. The method comprises reconditioning a rechargeable battery in response to a detected upcoming event, and charging the rechargeable battery after reconditioning. The upcoming event is a member of a list of events stored in computer-readable memory. Each member has respective occurrence information indicative of a date of occurrence or a date and time of occurrence in the list.

In other embodiments of the present invention, a battery charger with event-driven battery charging is provided. The battery charger comprises a list of events stored in a memory. An event has respective occurrence information that indicates a date of occurrence or a date and time of occurrence of the event. The battery charger further comprises a clock that provides a current indication of a date or a date and time and a battery charging subsystem. The battery charger further comprises a controller that accesses the memory and the clock and controls the battery charging subsystem. When the current indication from the clock corresponds to the respective occurrence information of an event on the list, the respective event is considered upcoming. The controller directs the battery charging subsystem to charge a rechargeable battery in response to the upcoming event.

In other embodiments of the present invention, a battery-powered device having event-driven battery charging is provided. The battery-powered device comprises means for detecting an upcoming event and means for in situ charging a rechargeable battery in the device. The upcoming event is a member of a list of events stored in the device. Each member has respective occurrence information indicative of a date of occurrence or a date and time of occurrence. The battery is charged by the means for in situ charging when the upcoming event is detected by the means for detecting. An upcoming event is detected when an indication of either a current date or a current date and time corresponds to occurrence information for a respective member of the list.

In still other embodiments of the present invention, a consumer electronics device having event-driven in situ battery charging is provided. The consumer electronics device comprises a real-time clock that provides a current indication of a date or a date and time. The device further comprises a charging subsystem having a charging circuit and a reconditioning circuit that connects to a rechargeable battery in the device. The consumer electronics device further comprises a memory subsystem and a list of events stored in the memory subsystem. The list comprises respective occurrence information for each event of the list. The consumer electronics device further comprises a controller that controls the charging subsystem and accesses' the clock and the memory subsystem, and a computer program further stored in the memory subsystem and executed by the controller. The computer program comprises instructions that, when executed by the controller, implement detecting an upcoming event. When upcoming event is detected, the instructions further implement in situ charging the rechargeable battery and optionally in situ reconditioning the battery before charging.

Certain embodiments of the present invention have other features in addition to and in lieu of the features described hereinabove. These and other features of the invention are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a flow chart of a method of event-driven battery charging according to an embodiment of the present invention.

FIG. 2 illustrates a flow chart of a method of event-driven battery reconditioning and charging according to an embodiment of the present invention.

FIG. 3 illustrates a block diagram of a battery charger that employs event-driven battery charging according to an embodiment of the present invention.

FIG. 4 illustrates a perspective view of an exemplary stand-alone battery charger according to an embodiment of the present invention.

FIG. 5 illustrates a perspective view of an exemplary battery charger implemented in a docking station for use with an exemplary digital camera according to an embodiment of the present invention.

FIG. 6 illustrates a block diagram of a battery-powered device that provides event-driven in situ batter charging according to an embodiment of the present invention.

FIG. 7 illustrates a block diagram of the exemplary embodiment of the battery-powered device illustrated in FIG. 6 according to an embodiment of the present invention.

### DETAILED DESCRIPTION

Embodiments of the present invention facilitate battery charging and reconditioning for a rechargeable battery used with a battery-powered device having a sporadic use model. In particular, timing of battery charging and reconditioning is coordinated with the use model of the device. The battery is charged or reconditioned and charged to place the battery at near peak charge capacity and/or near peak performance in anticipation of an upcoming event for which the battery-powered device will be used.

A method of event-driven battery charging charges a battery in response to a detected upcoming event. In particular, in some embodiments, the method charges the battery in advance of the detected upcoming event such that the battery is fully charged prior to the upcoming event. The method of event-driven charging may be performed as an in situ charging of a battery installed in an electronic device or may be performed on a battery that is removed from the device and placed in an external charging unit or system.

Event-driven battery charging according to the method facilitates establishing and/or maintaining a near or approximate peak charge capacity in the battery (i.e., a fully charged battery). In some embodiments, an optimum charge capacity of the battery is maintained. As used herein, ‘charge’ refers to energy stored by the battery, ‘charge capacity’ refers to an amount of energy that may be stored in a particular battery, and ‘charging’ refers to adding energy to a battery usually by using a charging current (or charging voltage and charging current) that is applied to terminals of the battery. Thus, a ‘peak charge capacity’ is an approximate maximum amount of energy that the battery can store. Moreover, for the purposes of discussion herein, energy stored by the battery is assumed to be essentially equal to energy that may be delivered by the battery.

In some embodiments, the peak charge capacity is established and/or maintained in anticipation of using the battery in the battery-powered device during the detected upcoming event. In particular, by establishing and/or maintaining the peak capacity of the battery, the method of event-driven battery charging may maximize a length of time the battery may be used by the battery-powered device during the event. Put another way, the method facilitates ensuring that the battery is fully ready for use in the battery-powered device during the event.

The method of event-driven battery charging is applicable to charging of a battery used in virtually any battery-powered device that utilizes a rechargeable battery. For example, the method of event-driven battery charging may be employed in conjunction with consumer electronic devices including, but not limited to, a digital camera, a laptop computer, a personal digital assistant (PDA), a compact disk (CD) player, an electronic toy, and a cellular telephone. Hereinafter, an ‘electronic’ device is also interchangeably referred to as a ‘battery-powered’ device.

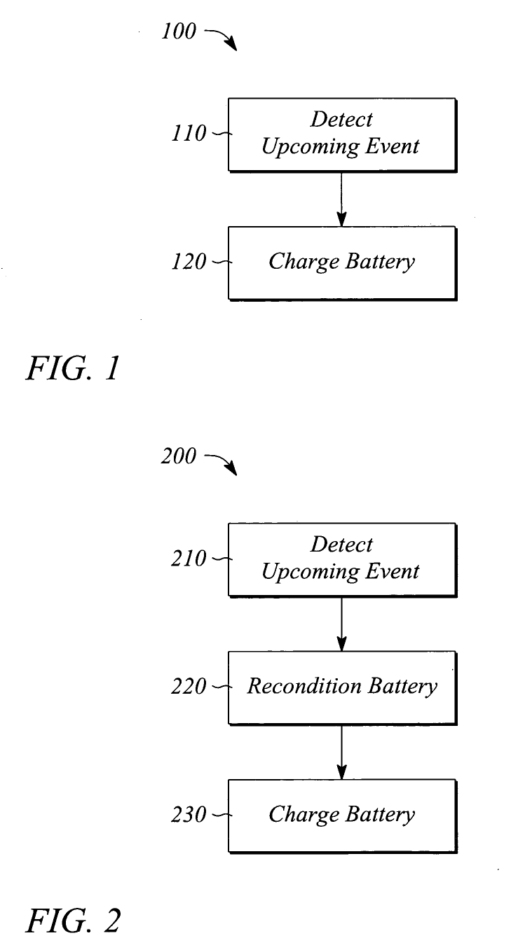

FIG. 1 illustrates a flow chart of an embodiment of a method 100 of event-driven battery charging according to an embodiment of the present invention. The method 100 of event-driven battery charging comprises detecting 110 an imminent or upcoming event, and charging 120 a battery in response to the detected event. The detected 110 upcoming event may represent a period of anticipated or expected usage of a battery. Specifically, the upcoming event may represent a period, at the start of which it may be desirable to have a fully charged battery to ensure that usage of the battery in a battery-powered device is maximized.

An event may be defined in terms of a calendar date for the event, wherein a calendar date includes a calendar start date for an event that lasts more than one day. Alternatively, both a calendar date and a time of day may define an event. In yet other instances, an upcoming event is defined by a day of the week as in the case of recurring weekly events. For example, anything that might be listed in a datebook or personal calendar might be considered an event. One skilled in the art may readily determine other definitions for events, all of which are within the scope of the present invention.

As such, in some embodiments, the upcoming event is detected 110 by comparing a current date to a date associated with an event in a list of events. The current date may be determined using a calendar or calendar function, for example. A calendar function is a function that tracks and/or determines a current date. For example, the calendar function may be implemented as a computer program or as an operational characteristic of either a discrete circuit or an integrated circuit (IC).

The upcoming event is detected 110 when the current date ‘matches’ the date associated with the event in the list of events. In other embodiments, the upcoming event is detected 110 by comparing a current date and a current time to respective date fields and time fields for events contained in a list or database of events. The current date and time may be determined using a clock of a device, for example. The upcoming event is detected 110 when the date and time fields of an event in the database ‘match’ the current date and time, respectively.

Comparing such dates and times may be performed one or both of periodically (e.g., every minute, hour, etc.) or aperiodically (e.g., during device startup of a battery-powered device). For example, the current date and time may be compared to the dates and times in the event list once every hour to look for a match. In another example, the current date is compared to listed event dates every time the battery-powered device is turned on or rebooted. In another example of aperiodic comparing, the current date and time might be compared when the battery-powered device is turned off or placed in a shutdown mode.

As used herein, ‘match’ may have any one or more various meanings depending on a specific embodiment of method 100. Thus, ‘match’ may mean ‘equal to’ in some embodiments. For example, in such instances a current date of Jan. 1, 2004 is said to match an event with a date of Jan. 1, 2004. Similarly, a current date and time of 12:00 AM, Jan. 1, 2004 is said to match a date and time of 12:00 AM, Jan. 1, 2004 of an event in the list or database. In other embodiments, ‘match’ may mean that the current date or current date and time is within a predetermined offset from the date or date and time in the list or database of events. For example, if an offset of ‘minus three hours’ is employed, a current date and time of 9:00 PM, Dec. 31, 2003 matches the event date/time of 12:00 AM, Jan. 1, 2004. An offset may be established to equal approximately an amount of time to charge or recondition and charge the particular battery.

In yet other embodiments, a current date or current date and time may match an event date or event date and time if the current date/time is within a predetermined time window around the event date/time. For example, if a time window of plus or minus one hour is employed, then a current date/time of 12:30 AM, Jan. 1, 2004 matches the event date/time of 12:00 AM, Jan. 1, 2004. In yet other embodiments, a match may mean that an event time has been passed. Thus, a current time of 3:00 AM may match an event time of 11:30 PM. Moreover, a match may assume one or more of the above meanings in certain embodiments of method 100. Also, as used herein with respect to detecting 110, ‘matching’ is generally assumed to be independent of a format of the current date/time and/or a format used to make and store entries in the event list or database.

In short and as is clear from the discussion hereinabove, the definition of ‘match’ is generally implementation dependent. That is, the meaning of ‘match’ generally depends on factors and conditions associated with a specific implementation of the method 100 including, but not limited to, a periodicity of comparing and how the comparison is performed. However, one skilled in the art may readily establish any meaning or meanings of ‘match’ without undue experimentation and be within the scope of the method 100. Therefore, ‘match’ herein generally means ‘correspond’ for the purposes of the embodiments of the present invention.

In some embodiments, the list or database of events is preprogrammed or predetermined. For example, a manufacturer of an electronic device that employs the method 100 may preprogram the list at time of manufacture to include holidays and similar dates known a priori to be likely dates for high battery usages. For example, the manufacturer of a device to be used in the United States might preprogram the list to include the Thanksgiving holiday or the Fourth of July holiday. Such a list would provide for detection 110 of holidays and similar dates as upcoming events. In addition to holidays, dates and/or dates and times associated with other expected or anticipated periods of high usage levels of a battery-powered device may be incorporated into the list. For example, the list may include a weekly entry for Friday in anticipation of possible high usage levels of the battery on a succeeding Saturday and/or Sunday.

In other embodiments, the list of events may be programmable and/or modifiable (e.g., reprogrammable) by a user of a device that employs the method 100. For example, a user may program events such as holidays, birthdays, anniversaries and other dates of personal meaning or interest to the user. Such a list might include a pre-planned annual vacation and dates of upcoming graduation ceremonies, for example. In addition, a list that is user programmable and modifiable enables a user to change the program periodically to accommodate changes to the user's schedule or plans. For example, a user who typically uses a battery-powered device on weekends, but for a period of time will instead use the device on Mondays and Tuesdays, for example, can modify the program to include those days as weekly events, for example, and then change the program again when desired.

In yet other embodiments, the list may include both predetermined events and user-programmed events. Thus, a manufacturer may establish a list that is then added to and/or modified by the user. As such, a user that normally has Monday and Tuesday off from work might remove a preprogrammed Friday event from the list in favor of a Sunday event, for example.

In yet other embodiments, a record of a use pattern or use model of the battery-powered device is created or maintained. The use model may be generated from a historical record of how the device is actually used, for example. From such a use model that includes the historical record of use, periods of high usage may be determined. In turn, the determined periods of high usage may be employed to establish and/or modify events in the database. Thus for example, the use model may indicate that the Saturday and Sunday following the Thanksgiving holiday typically represents a high usage period for the device. As a result, the Friday following Thanksgiving may be added to the list as an event for detection 110. In other cases, the use model may indicate that one or more events in the list do not, in fact, represent periods of high usage. In such situations, the use model may be used to select events that can be safely deleted from the list. In yet other embodiments, one or more of predetermined events, user programmed events, and use-model determined events are included in the list.

Referring again to FIG. 1, the method 100 further comprises charging 120 a battery in response to detection 110 of the upcoming event. In general, specifics of charging 120 are embodiment dependent. In particular, in some embodiments, charging 120 may include, but is not limited to, one or more of charging, rapid charging, top-off charging, and trickle charging. Charging refers to any conventional approach or method of charging (or recharging) a rechargeable battery. For example, charging may comprise applying a charging current to terminals of the battery. Rapid charging is generally differentiated from charging by a relative speed with which energy is delivered to the battery for storage as the battery charge. Some rapid charging methods use a pulse or time varied charging current to increase a charging speed, for example.

Top-off charging refers to various methods by which energy is added to that already stored in the battery to establish and/or re-establish a peak or maximum capacity charge. For example, rapid charging is often terminated before a peak charge is reached (e.g., at 80-90% peak charge) in order to avoid damaging the battery by overcharging. In such instances, top-off charging may be employed after the rapid charging is terminated to finish charging the battery, thereby establishing the peak charge (e.g., approximately 100% peak charge). In other instances, top-off charging is used to re-establish the peak charge on a previously charged battery when some of the charge is lost during a battery storage period. Charge is often lost over time when a battery is stored due to internal leakage currents within the battery.

Trickle charging refers to an application of a small current (i.e., a trickle current) to the battery. Often, trickle charging is employed to offset a loss of charge due to internal leakage currents within the battery, thereby maintaining a peak charge on the battery. Hereinafter, any or all of charging, rapid charging, top-off charging, and trickle charging will be referred to interchangeably as ‘topping-off’ a charge of the battery when discussing charging 120 the battery of the method 100. As such, charging 120 generally comprises topping off a charge of the battery when an upcoming event is detected 110.

FIG. 2 illustrates a flow chart of a method 200 of event-driven battery reconditioning and charging according to an embodiment of the present invention. In some embodiments, the method 200 is essentially the method 100 that further comprises optionally reconditioning the battery prior to being charged in advance of an upcoming event.

As used herein, ‘conditioning’ or ‘reconditioning’ refers to any maintenance process applied to a battery to maintain or re-establish a proper operational condition of the battery (e.g., peak charge capacity performance). For example, NiCd batteries are known to suffer from a ‘memory effect’ that may reduce a peak charge capacity performance of the battery over time. Specifically, without periodic conditioning during use, NiMH and NiCd batteries often develop a reduced ability to store energy or charge due to a build up of conditions internal to the battery. The reduced charge capacity eventually renders the battery unusable. Regular, periodic battery conditioning of NiMH and NiCd batteries helps to reduce or even reverse the reduction of charge capacity.

For example, a type of reconditioning which applies to NiMH and NiCd batteries comprises discharging the battery and then charging the battery. The battery is discharged to a charge level beyond (i.e., below) a normal operational ‘cut-off’ charge level for a given or intended use of the battery. In particular, the battery is discharged to an ‘end-of-discharge’ condition without over discharging. The end-of-discharge condition depends on a given battery chemistry and therefore, is specific to or appropriate for the given battery chemistry. Therefore, the present invention is not intended to be limited to any particular ‘end-of-discharge’ condition. One skilled in the art is familiar with determining such an end-of-discharge condition for a given battery chemistry and may readily determine whether a battery is being over discharged without undue experimentation. For examples of reconditioning see pending patent application of Melton et al., U.S. Ser. No. 10/295,107, incorporated herein by reference.

The battery is then charged to a level near a maximum charge level or capacity of the battery. As such, ‘discharging’ in the context of reconditioning generally is referred to as ‘deeply discharging’ indicating that the discharging reduces the battery charge level to below, preferably well below, the normal cut-off charge level. Similarly, ‘charging’ in the context of reconditioning is often referred to as ‘fully charging’ since an attempt generally is made to achieve a maximum charge capacity of the battery. Since charging the battery is specific to and dependent on a given battery chemistry, the present invention is not intended to be limited to any particular ‘charging’ or ‘fully charging’ condition. One skilled in the art is familiar with and may readily determine the meaning of ‘deeply discharging’ and ‘fully charging’ with respect to a given battery chemistry for the purposes of battery conditioning without undue experimentation.

During reconditioning, discharging the battery may be performed using a low discharge rate relative to a typical discharge rate of the battery during use in a battery-powered device. Several cycles of such low discharge rate discharging may be applied during a particular battery reconditioning. The low discharge rate may be achieved by applying a light, low or small load to the battery during a discharge period. The application of the small load results in a low rate of energy discharge or a low energy drain from the battery.

For example, the small load may comprise using a ‘low power’ mode of the electronic device in which the battery is installed. Alternatively, connecting a relatively high value resistor (e.g., 1K ohm to 1M ohm) across terminals of the battery during the discharge period may be used as the small load or a moderately small load. In general, the definition of what constitutes a small load to a moderately small load depends, in part, on an overall capacity of the battery. However, one skilled in the art is familiar with and can readily determine a small to moderately small load for a given battery and battery capacity without undue experimentation.

Referring again to FIG. 2, the method 200 of event-driven battery reconditioning and charging comprises detecting 210 an upcoming event. Detecting 210 is essentially similar to detecting 110 described hereinabove for the method 100. As such, in some embodiments, the upcoming event is detected 110 by comparing a current date/time to a date/time associated with an event in a list or database of events. The upcoming event is detected 110 when the date/time of an event in the list or database ‘matches’ the current date/time as described hereinabove with respect to method 100. Likewise, comparing may be performed one or both of periodically (e.g., every minute, hour, etc.) or aperiodically (e.g., during device startup).

The method 200 further comprises reconditioning 220 a battery when an upcoming event is detected 210. In some embodiments, reconditioning 220 is performed in response to each detected 210 upcoming event. In other embodiments, reconditioning 220 is performed for selected or predetermined detected 210 upcoming events. For example, certain events may be ‘marked’ in the list or database in such a way as to indicate that reconditioning 220 is to be performed. When such an event is detected, reconditioning 220 is performed while reconditioning 220 is not performed for events that are not so marked. In other embodiments, reconditioning 220 may be performed in response to a detected upcoming event only if a sufficient or predetermined amount of time or number of battery discharge cycles has occurred. For example, if a ‘last’ reconditioning was performed twenty discharge cycles ago, reconditioning 220 may be performed in response to a ‘next’ detected 210 upcoming event.

The method 200 further comprises charging 230 the battery after detecting 210 an upcoming event, or after detecting 210 an upcoming event and reconditioning 220 the battery, depending on the embodiment. Charging 230 is essentially similar to charging 220 described hereinabove with respect to method 100. In particular, in various embodiments, charging 230 may include, but is not limited to, one or more of charging, rapid charging, top-off charging, and trickle charging as described hereinabove.

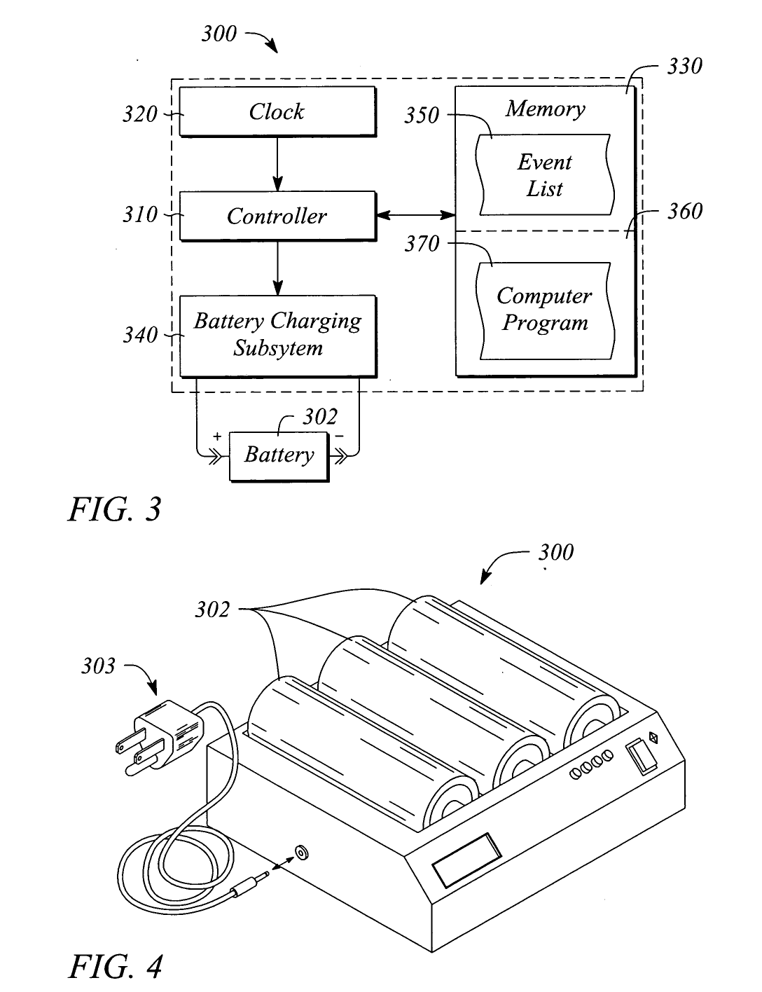

FIG. 3 illustrates a block diagram of a battery charger 300 that employs event-driven battery charging according to an embodiment of the present invention. The battery charger 300 accepts a battery 302 and provides event-driven battery charging of the battery 302. Specifically, the battery charger 300 detects an upcoming event by comparing a current date/time with date/time information in a list or database of events. An upcoming event is detected when the current date/time matches the date/time of one or more events in the list. Upon detecting the upcoming event, the battery charger 300 charges the battery 302. In some embodiments, event-driven battery charging includes event-driven battery reconditioning that provides reconditioning of the battery 302 prior to charging. As such, the battery charger 300 may essentially implement one of the method 100 or the method 200 described hereinabove.

The battery charger 300 comprises a controller 310, a clock 320, a memory 330, and a battery charging subsystem 340. The memory 330 contains a list or database of events 350 and date/time information corresponding to the events. The clock 320 provides an indication of a current date or current date and time to the controller 310. The controller 310 receives date/time inputs from the clock 320 and consults the event list 350 stored in memory 330 to detect upcoming events. The controller 310 also may provide inputs to the memory 330 such as, but not limited to, changes to the list 350. The controller 310 is connected to and provides control outputs to the battery charging subsystem 340. In particular, when an upcoming event is detected, the controller 310 instructs the battery charging subsystem 340 to either charge the battery 302 or recondition and charge the battery 302.

The controller 310 may be any sort of component or group of components capable of interfacing with, such as receiving and processing inputs from, providing control to, and coordinating activities of, the clock 320, the memory 330, and the battery charging subsystem 340. For example in some embodiments, the controller 310 is a microprocessor or microcontroller. In other embodiments, the controller 310 is implemented as an application specific integrated circuit (ASIC) or portion thereof. In yet other embodiments, the controller 310 even may be an assemblage of discrete components such as, but not limited to, logic gates, transistors, capacitors, and resistors. One or more of a digital data bus, a digital line, or analog line may provide interfacing between the controller 310 and the other elements of the battery charger 300. In some embodiments, the clock 320 may be built into or is a part of the controller 310. Likewise, in some embodiments a portion or all of the memory 330 is combined with or may be built into the controller 310 (e.g., microcontroller flash memory).

The clock 320 may be any clock or clock function that provides an indication of a current date and/or a current time. A specific format and an accuracy/precision of the current date/time indication are dependent on a specific implementation of the battery charger 300. For example, the clock 320 may be a digital real-time clock (e.g., a real-time clock built into the controller 310). In another example, the clock 320 is an electromechanical timer. In yet another embodiment, the clock 320 may be a computer program executed by a general-purpose computer or even executed by the controller 310 itself.

The memory 330 may be any memory that can store the list or database of events 350 and the associated date/time information for the events. For example, the memory 330 may be one or more pins inserted in or attached to a rotating wheel associated with a mechanical clock 320. In such an implementation, the list 350 may correspond to a pattern of pins distributed around a periphery of the wheel.

In another example, the memory 330 may be an electronic or digital memory including, but not limited to, one or more of read-only memory (ROM), programmable ROM (PROM), electrically erasable PROM (EEPROM), other types of flash memory, random access memory (RAM), and battery-backed RAM. In yet another example, the memory 330 may be disk drive or similar computer readable media drive such as, but not limited to, a hard disk drive (HDD), floppy disk or diskette drive, a tape drive, and an optical drive (e.g., CD or DVD drive).

In such cases, the list 350 comprises a pattern or sequence of bits stored in the memory 330. For example, the list 350 may comprise a database file or files stored in RAM or on a disk drive. When needed, the list 350 is accessed or ‘read’ from the memory 330 by the controller 310. For example, the controller 310 may access the database file(s) to compare a current time received from the clock 320 to the date/time information for events in the list 350 stored in the memory 330.

The battery charging subsystem 340 accepts the battery 302 and provides one or both of charging and reconditioning and charging of the battery 302. A command or instruction from the controller 310 initiates the charging and/or reconditioning and charging.

The battery charging subsystem 340 may be implemented as an assemblage of discrete components, as an ASIC or portion thereof, of as specialized battery charging integrated circuit. For example, the battery charging subsystem 340 may be implemented using a MAX1737 Stand-Alone Switch-Mode Lithium-Ion Battery-Charger Controller, manufactured and marketed by MAXIM Integrated Products, Sunnyvale, Calif. The MAX1737 provides a shutdown input to start and stop battery charging. Another example of a specialized integrated circuit for implementing the battery charging subsystem 340 is a MAX1908, MAX8724 Low-Cost Multichemistry Battery Charger, also manufactured and marketed by MAXIM Integrated Products. The MAX1908/MAX8724 accommodates a variety of battery types (e.g., NiMH, NiCd, Li, etc.) while the MAX1737 is designed primarily for Li Ion batteries. A wide variety of other specialized integrated circuits from this and other manufacturers is readily available for use in implementing the battery charging subsystem 340.

In general, the battery charging subsystem 340 receives power for charging from a source external to the battery charger 300. For example, the battery charging subsystem 340 may receive power from an alternating current (AC) electrical outlet (e.g., wall outlet). In another example, the battery charging subsystem 340 may receive power for charging from a direct current (DC) auxiliary equipment port such as is often found in an automobile or an aircraft. In some cases, an AC/DC adapter or a DC/DC converter may be employed between the battery charging subsystem 340 and the power source to convert and/or precondition the charging power.

Referring again to FIG. 3, in some embodiments, the battery charger 300 further comprises a memory 360 and a computer program 370 stored in the memory 350. The memory 360 may be a portion of the memory 330 as illustrated in FIG. 3 or may a different memory. The controller 310 accesses the memory 360 to execute the computer program 370.

The computer program 370 comprises instructions that implement event-driven battery charging according to embodiments of the present invention. In some embodiments, the instructions of the computer program 370 implement the method 100 of event-driven battery charging described hereinabove. In some embodiments, the instructions of the computer program 370 implement the method 200 of event-driven battery charging described hereinabove.

In particular, instructions of the computer program 370 implement detecting an upcoming event by comparing a current date/time to date/time information for the events stored in the list 350 in the memory 330. The instructions further implement initiating charging or reconditioning/charging when an upcoming event is detected. The charging or reconditioning/charging facilitate establishing and maintaining a peak charge on the battery 302 in anticipation of using the battery 302 in the battery powered device during the upcoming event.

In some embodiments, the battery charger 300 further comprises a user interface (not illustrated). The user interface may be employed to program the electronic device and/or program the list 350 as well as to monitor and provide control inputs to the battery charger 300. In such embodiments, the controller 310 is interfaced to the user interface.

The battery charger 300 may be realized in a variety of different form factors and physical configurations. For example, in some embodiments the battery charger 300 is a stand-alone unit or system adapted to accept and charge rechargeable batteries. FIG. 4 illustrates a perspective view of an exemplary stand-alone battery charger 300 according to an embodiment of the present invention. As illustrated in FIG. 4, batteries 302 are inserted into the battery charger 300 for charging and then removed and placed in a battery-powered device for use in powering the device (not illustrated). The battery charger 300 implemented as a stand-alone unit may be capable of accommodating and charging one or more batteries 302 at a time. Moreover, the battery charger 300 may be adapted to work with one or more of batteries 302 having a conventional form factor (e.g., AA, D, C) as illustrated in FIG. 4 and use-specific battery packs (not illustrated). A use-specific battery pack is a battery pack having a custom or semi-custom form factor (i.e., a non-conventional form factor) that is designed for use with a specific device or group of devices (e.g., a laptop computer battery pack). A power cord 303 for connecting the battery charger 300 to an AC outlet is illustrated in FIG. 4 by way of example.

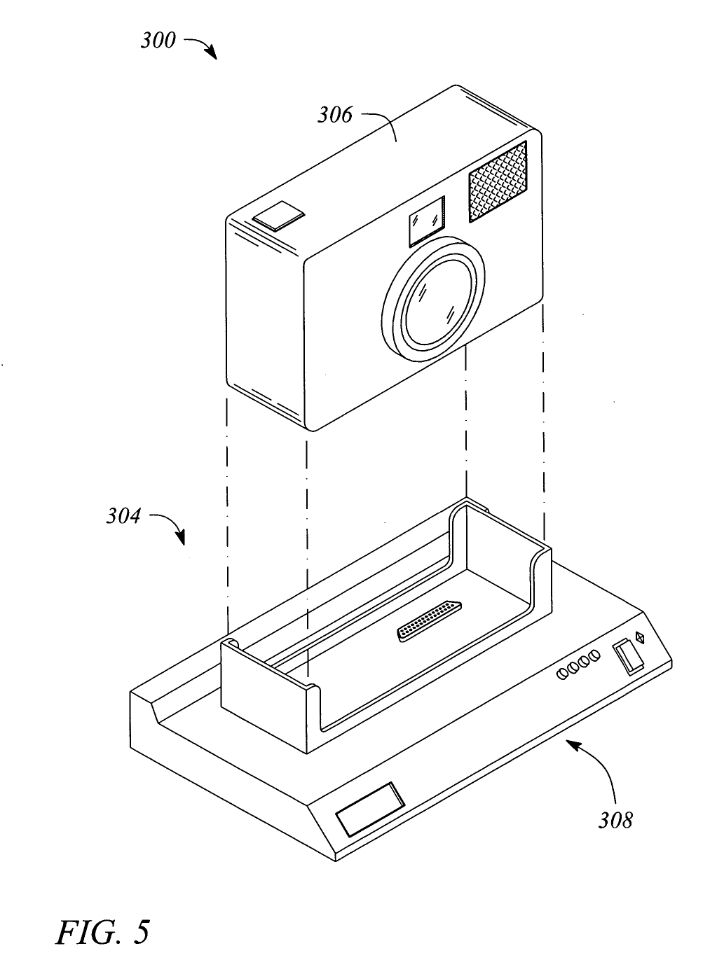

In other embodiments, the battery charger 300 is implemented as, or integrated into, another element or component used in conjunction with a battery-powered device such as, but not limited to, a docking station, base unit, and storage rack. FIG. 5 illustrates a perspective view of an exemplary battery charger 300 implemented in a docking station 304 for use with an exemplary digital camera 306 according to an embodiment of the present invention. In such embodiments, the battery charger 300 may provide in situ charging of one or more batteries installed in the electronic device (e.g., digital camera 306). A user interface 308 for programming and/or reprogramming the list 350 is illustrated in FIG. 5. The user interface 308 comprises buttons and a display on a surface of the docking station 304. Alternatively, a user interface (not illustrated) on the electronic device 306 may be used for programming and/or reprogramming the list 350 while the electronic device 306 is docked to the docking station 304.

In yet other embodiments, the battery charger 300 may be implemented in a distributed manner (not illustrated). For example, the controller 310, clock 320, and memory 330, 350 may be part of a personal computer (PC). The PC may be connected to a controllable battery charger subsystem 340. By executing the computer program 360, the PC controls the operation of the battery charger subsystem 340 as described hereinabove. In another example of a distributed implementation (not illustrated) of the battery charger 300, the battery charging subsystem 340 and battery 302 may be located in a battery-powered device and the controller 310, the clock 320, and the memory 330 may be located in a docking station or charging interface unit used in conjunction with the device. One skilled in the art may readily devise any number of such different distributed implementations, all of which are within the scope of the present invention.

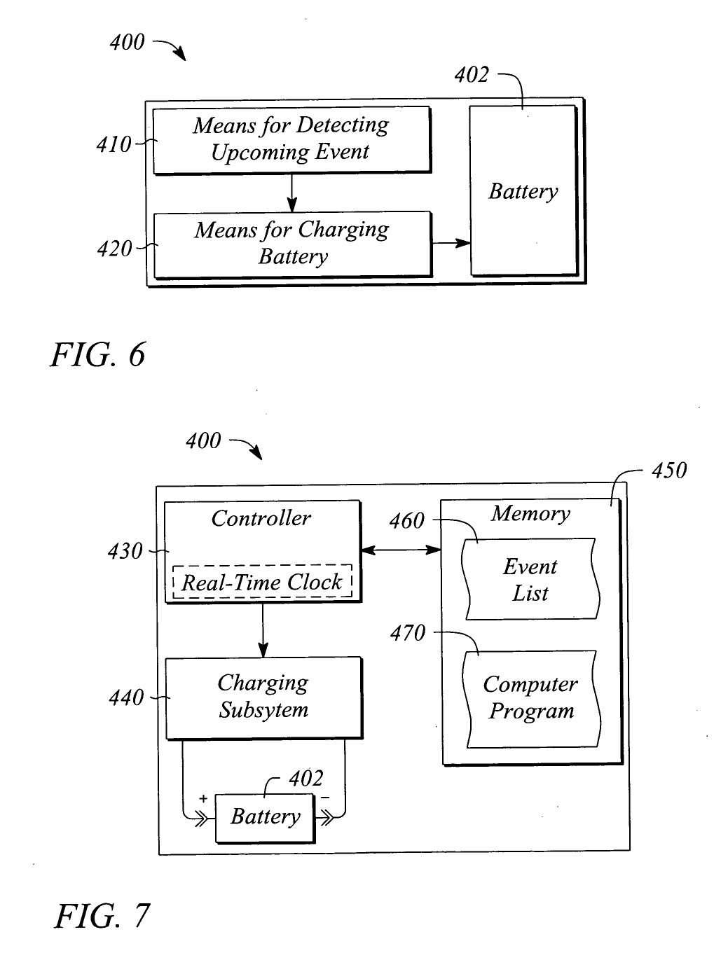

FIG. 6 illustrates a block diagram of a battery-powered device 400 that provides event-driven in situ battery charging according to an embodiment of the present invention. The battery-powered device 400 having a rechargeable battery 402 comprises means for detecting 410 an upcoming event. The means for detecting 410 uses a current date/time and date/time information regarding events to detect the upcoming event. The device 400 further comprises means for charging 420 the battery 402. The means for charging 420 either charges or reconditions and then charges the battery 402 in response to detecting the upcoming event. As a result, the battery 402 of the device 400 is more likely to have a peak charge capacity when the upcoming event occurs, thereby maximizing a useful operational time for the battery-powered device 400 during the event.

In some embodiments, the means for detecting 410 the upcoming event comprises means for generating a current date or a current date and current time. The means for detecting 410 further comprises a means for comparing the current date/time to the event date/time information. An upcoming event is detected when the current date/time corresponds to date/time information from one or more of the events, as described above for detecting 110, 210 of the method 100, 200.

In some embodiments, the means for charging 420 the battery 402 comprises a controllable battery charging circuit. A control switch or control function of the controllable battery charging circuit enables the means for charging 420 to be turned on and turned off (i.e., enabled and disabled) according to whether or not an upcoming event has been detected by the mean for detecting 410. Furthermore, the means for charging 420 may apply a charge to the battery 402 using one or more of charging, rapid charging, top-off charging, and trickle charging. The result of applying the charge is to effect a ‘topping off’ of the charge on the battery 402. In addition, in some embodiments the means for charging 420 may recondition the battery 402 prior to charging the battery 402.

Consider for example, an exemplary embodiment of the battery-powered device 400 in the form of a consumer electronics device 400, such as, but not limited to, a digital camera. The exemplary battery-powered device provides in situ event-driven battery reconditioning and charging of the battery 402 according to embodiments of the present invention. In particular, the battery 402 is reconditioned and charged in advance of a detected upcoming event while the battery 402 is installed in the device 200. FIG. 7 illustrates a block diagram of the exemplary embodiment of the battery-powered device 400 illustrated in FIG. 6 according to an embodiment of the present invention.

As illustrated in FIG. 7, the exemplary electronic device 400 further comprises a controller 430 having a real-time clock, a charging subsystem 440, a memory 450, a list of events 460, and a computer program 470. The list of events 460 and the computer program 470 are both stored in the memory subsystem 450. The means for detecting 410 an upcoming event comprises the aforementioned controller 430, the memory 450, the list of events 460 and an event detecting portion or function of the computer program 470. The means for charging 420 comprises the aforementioned controller 430, the charging subsystem 440, and a charging control portion or function of the computer program 470.

The real-time clock of the controller 430 periodically generates a current date and time. The event-detecting portion of the computer program 470 comprises instructions that, when executed by the controller 430, compare the generated current date and time to respective date and time fields of the events in the list of events 460. The comparison produces an event detection when one or more of the date/time fields match the current date/time. For example, the instructions may implement detecting 110, 210, respectively, of the method 100 of event-driven charging or the method 200 of event-driven reconditioning and charging, as previously described hereinabove. The controller 430 executes the instructions that may include retrieving date/time data from the memory subsystem 450. The result of the executed instructions by the controller 430 is a detection of the upcoming event when a match is made.

The controller 430 controls the charging subsystem 440. Under such control, the charging subsystem 440 may discharge the battery 402 for reconditioning purposes as well as charge the battery 402. In particular, the charging subsystem 440, through a connection to an external power source, such as an alternating current (AC) adapter, provides means for charging the battery 402 when commanded to do so by the controller 430. Likewise, the charging subsystem 440 provides a means for discharging the battery 402 either by providing operational power to the device 400 or by switching an output of the battery 402 to a load resistor (not illustrated) to facilitate battery reconditioning.

The charging control portion of the computer program 470 comprises instructions that, when executed by the controller 430, initiate and control reconditioning and charging. For example, the instructions may implement either charging 120 or reconditioning and charging 220, 230 described hereinabove with respect to the methods 100, 200, respectively. Moreover, the instructions may implement a method or process of establishing when and whether to recondition depending on which upcoming event is detected and/or other factors including, but not limited to, an elapse time from a last or previous reconditioning and usage of the battery since the last reconditioning. The result of the execution of the instructions by the controller 430 is the reconditioning and charging of the battery 402 in situ within the device 400 when an upcoming event is detected.

When the exemplary electronic device 400 of FIG. 7 is implemented as a digital camera, the controller 430 comprises a microprocessor and a microcontroller (not illustrated). Typically, the microcontroller provides much lower power consumption than the microprocessor and is used to implement low power-level tasks, such as monitoring button presses of a user interface (not illustrated) and implementing the real-time clock function of the digital camera 400. The microcontroller is primarily responsible for controller 430 functionality that occurs while the digital camera 400 is in a ‘stand-by’ or a ‘shut-down’ mode. The microcontroller executes a relatively simple computer program. This computer program is stored as firmware in read-only memory (ROM), for example. In some embodiments, the ROM is built into the microcontroller.

The microprocessor implements the balance of the controller-related functionality. In particular, the microprocessor is responsible for all of the computationally intensive tasks of the controller 430, including but not limited to, image formatting, file management of the file system in the memory subsystem 450, and digital input/output (I/O) formatting for an I/O port or ports of the digital camera's user interface. The microprocessor executes a control program stored in the memory subsystem 450. Instructions of the control program implement the control functionality of the controller 430 with respect to the digital camera 400. A portion of the control program is the computer program 470 described hereinabove. Moreover, the charging subsystem 440 may be a typical power subsystem of the digital camera 400 that is augmented for the purposes of some embodiments of the present invention with a control functionality to enable the controller 430 to initiate charging or reconditioning and charging when an upcoming event is detected. Furthermore, in some embodiments the digital camera user interface may be employed to program or reprogram events in the list 460.

Thus, there have been described embodiments of a method of event-driven battery charging or reconditioning and charging as well as embodiments of a battery charger and a battery-powered device each providing event-driven battery charging or reconditioning and charging. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

1. A method of event-driven battery charging of a battery, the method comprising:
charging a rechargeable battery in response to a detected upcoming event, the upcoming event being a member of a list of events stored in computer-readable memory, each member having respective occurrence information in the list that indicates a date or a date and time of occurrence.

2. The method of event-driven battery charging of claim 1, further comprising:
detecting the upcoming event, the upcoming event being detected either when a current date or when a current date and time corresponds to the occurrence information for a respective member of the list of events.

3. The method of claim 1, further comprising:
reconditioning the rechargeable battery before charging.

4. The method of claim 1, wherein charging a rechargeable battery comprises one or more of charging, rapid charging, top-off charging, and trickle charging to establish or re-establish an approximate peak charge or peak capacity of the battery.

5. A method of event-driven battery charging of a rechargeable battery, the method comprising:
detecting an upcoming event, the upcoming event being a member of a list of events stored in computer-readable memory, each member having respective occurrence information indicative of a date of occurrence or a date and time of occurrence; and
charging a battery in response to the detected upcoming event,
wherein the upcoming event is detected when either a current date or a current date and time corresponds to the occurrence information for a respective member of the list of events.

6. The method of claim 5, further comprising:
reconditioning the battery before charging.

7. The method of claim 5, further comprising:
programming the list of events into the computer-readable memory, the programmed list being optionally reprogrammable.

8. The method of claim 5, wherein charging a battery establishes or re-establishes an approximate peak charge or peak capacity of the battery.

9. A method of event-driven battery charging of a battery, the method comprising:
reconditioning a rechargeable battery in response to a detected upcoming event; and
charging the rechargeable battery after reconditioning,
wherein an upcoming event is a member of a list of events stored in computer-readable memory, each member having respective occurrence information that indicates a date of occurrence or a date and time of occurrence in the list.

10. The method of claim 9, further comprising:
detecting the upcoming event, the upcoming event being detected either when a current date or when a current date and time corresponds to the occurrence information for a respective member of the list of events.

11. The method of claim 9, wherein charging the battery comprises one or more of charging, rapid charging, top-off charging, and trickle charging to establish or re-establish an approximate peak charge or peak capacity of the battery.

12. The method of claim 9, wherein reconditioning a rechargeable battery comprises reconditioning only when one or more of the detected upcoming event in the list is preselected for reconditioning, a predetermined amount of time has passed and a predetermined number of battery discharge cycles has occurred.

13. A method of event-driven battery charging of a rechargeable battery, the method comprising:
detecting an upcoming event, the upcoming event being a member of a list of events stored in computer-readable memory, each member having respective occurrence information indicative of a date of occurrence or a date and time of occurrence;
reconditioning a battery in response to the detected upcoming event; and
charging the battery after reconditioning,
wherein the upcoming event is detected when either a current date or a current date and time corresponds to the occurrence information for a respective member of the list of events.

14. The method of claim 13, further comprising:
programming the list of events into the computer-readable memory, the programmed list being optionally reprogrammable.

15. The method of claim 13, wherein charging the battery establishes or re-establishes an approximate peak charge or peak capacity of the battery.

16. A battery charger with event-driven battery charging comprising:
a list of events stored in a memory, an event having respective occurrence information that indicates a date of occurrence or a date and time of occurrence of the event;
a clock that provides a current indication of a date or a date and time;
a battery charging subsystem; and
a controller that accesses the memory and the clock and controls the battery charging subsystem,
wherein when the current indication from the clock corresponds to the respective occurrence information of an event on the list, the respective event is considered upcoming, the controller directing the battery charging subsystem to charge a rechargeable battery in response to the upcoming event.

17. The battery charger of claim 16, wherein the battery charger subsystem comprises means for reconditioning the rechargeable battery, the controller optionally directing the battery charging subsystem to recondition the rechargeable battery before charging in response to the upcoming event.

18. The battery charger of claim 16, further comprising a computer program stored in the memory and executed by the controller, the computer program comprising instructions that, when executed by the controller, implement detecting the upcoming event and charging the battery in response to the detected upcoming event.

19. The battery charger of claim 18, wherein the computer program further comprises instructions that, when executed by the controller, implement reconditioning the battery in response to the detected upcoming event before charging.

20. The battery charger of claim 16, further comprising a housing and an adaptor, the housing comprising a receptacle that receives the rechargeable battery, the receptacle being interfaced to the battery charging subsystem, the adaptor connecting external power to the battery charging subsystem.

21. The battery charger of claim 16, further comprising a housing, the housing having a connector within a receptacle, the receptacle receiving a battery-powered electronic device, the connector interfacing the rechargeable battery of the device to the battery charging subsystem when the device is received in the receptacle, the rechargeable battery being in situ charged while the electronic device is received in the housing receptacle in response to the upcoming event.

22. A battery-powered device having event-driven battery charging, the device comprising:
means for detecting an upcoming event, the upcoming event being a member of a list of events stored in the device, each member having respective occurrence information indicative of a date of occurrence or a date and time of occurrence; and
means for in situ charging a rechargeable battery in the device,
wherein the upcoming event is detected by the means for detecting when an indication of either a current date or a current date and time corresponds to occurrence information for a respective member of the list, the battery being charged by the means for in situ charging when the upcoming event is detected.

23. The battery-powered device of claim 22, wherein the means for detecting comprises means for generating the current date or the current date and time indication; and means for comparing the current date or the current date and time to respective occurrence information for members of the list of events.

24. The battery-powered device of claim 22, wherein the means for in situ charging comprises a battery charging circuit controlled by means for controlling that enable and disable the battery charging circuit depending on whether the upcoming event is detected.

25. The battery-powered device of claim 24, wherein the means for in situ charging further comprises a battery reconditioning circuit further controlled by the means for controlling to enable and disable the reconditioning circuit depending on whether the upcoming event is detected, the enabled reconditioning circuit reconditioning the battery before charging when the upcoming event is detected.

26. The battery-powered device of claim 24, wherein the means for controlling is a control switch.

27. The battery-powered device of claim 22, further comprising:
means for programming the list of events into the device, the means for programming optionally comprising reprogramming the programmed list of events.

28. A consumer electronics device having event-driven in situ battery charging comprising:
a real-time clock that provides a current indication of a date or a date and time;
a charging subsystem having a charging circuit and a reconditioning circuit that connects to a rechargeable battery in the device;
a memory subsystem;
a list of events stored in the memory subsystem, the list comprising respective occurrence information for each event of the list;
a controller that controls the charging subsystem and accesses the clock and the memory subsystem; and
a computer program further stored in the memory subsystem and executed by the controller, the computer program comprising instructions that, when executed by the controller, implement detecting an upcoming event, the executed instructions further implementing in situ charging the rechargeable battery and optionally in situ reconditioning the battery before charging in response to a detected upcoming event.

29. The consumer electronics device of claim 28, wherein the computer program comprises an event detection subprogram, the event detection subprogram comprising instructions that, when executed by the controller, implement comparing the current indication on the real-time clock to the occurrence information from the list of events in the memory subsystem to determine any correspondence between the current indication and the occurrence information for a respective event.

30. The consumer electronics device of claim 29, wherein the computer program further comprises a charging subprogram, the charging subprogram comprising instructions that, when executed by the controller, implement the in situ charging of the rechargeable battery, and the optionally in situ reconditioning the rechargeable battery before charging with the charging subsystem.

31. The consumer electronics device of claim 30, wherein the charging subprogram further comprises instructions that, when executed by the controller, implement establishing whether to recondition the rechargeable battery before charging based on one or more of a type of detected event, an elapse time from a last reconditioning, and a battery usage since the last reconditioning.

32. The consumer electronics device of claim 28, wherein the occurrence information for each respective event in the list of events indicates a date of occurrence or a date and time of occurrence.

33. The consumer electronics device of claim 28, further comprising a user interface that provides a user of the device access to the list of events in the memory subsystem, the list of events being personalized for the user by one or both programming and reprogramming an event of the list using the user interface.

34. The consumer electronics device of claim 28, further comprising an adaptor that interfaces the device to external power, the adaptor providing the external power to the charging subsystem to charge the rechargeable battery.
